(19) United States
(12) Patent Application Publication
(10) Pub. No.: US 2018/0088977 A1
(43) Pub. Date: Mar. 29, 2018

(54) TECHNIQUES TO DETERMINE AND MITIGATE LATENCY IN VIRTUAL ENVIRONMENTS

(71) Applicants: MARK GRAY, SHANNON (IE); ANDREW CUNNINGHAM, ENNIS (IE); CHRIS MACNAMARA, LIMERICK (IE); JOHN BROWNE, LIMERICK (IE); PIERRE LAURENT, QUIN (IE); ALEXANDER LECKEY, KILCOCK (IE)

(72) Inventors: MARK GRAY, SHANNON (IE); ANDREW CUNNINGHAM, ENNIS (IE); CHRIS MACNAMARA, LIMERICK (IE); JOHN BROWNE, LIMERICK (IE); PIERRE LAURENT, QUIN (IE); ALEXANDER LECKEY, KILCOCK (IE)

(21) Appl. No.: 15/279,380

(22) Filed: Sep. 28, 2016

(51) Int. Cl. G06F 9/455

(52) U.S. Cl. CPC G06F 9/45558; H04L 43/0852; G06F 2009/45595; G06F 2009/45591

(57) ABSTRACT

Embodiments may be generally directed to techniques to cause communication of one or more packets from one or more network interfaces to one or more other network interfaces through a virtual machine monitor, determine at least one of latency and jitter for the virtual machine monitor based, at least in part, on each of the one or more packets communicated through the virtual machine monitor, and perform a corrective action when at least one of the latency and the jitter does not meet a requirement for a virtual machine on the virtual machine monitor.

### TECHNICAL FIELD

Embodiments described herein generally relate to communicating packets through a virtual machine monitor to determine latency and jitter.

### BACKGROUND

The utilization of virtual environments to provide services and capabilities is becoming more and more prevalent in today's computing environment. Virtual environments are being used to provide services with high availability and traffic latency requirements. For example, telecommunication companies are using these environments to provide telecom services to users. Systems that provide these services are constantly monitored to ensure that the services are being provided and meet the stringent requirements stipulated by the customers. Embodiments are directed to solving these other problems.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1A illustrates an example of a system.

FIG. 1B illustrates an example of a system.

FIG. 1C illustrates an example of a system.

FIGS. 2A-2C illustrate examples of logic flows.

FIG. 3 illustrates an example of a processing flow.

FIG. 4 illustrates an example of a logic flow.

FIG. 5 illustrates an example of a computing system.

FIG. 6 illustrates an example of a computer architecture.

### DETAILED DESCRIPTION

Various embodiments discussed herein may include methods, apparatuses, devices, and systems to determine latency and jitter caused by a virtual machine monitor, such as hypervisor®. For example, embodiments may include causing one or more “tracer” packets to be communicated between network interfaces though the virtual machine monitor. The network interfaces may include virtual network interfaces and be associated with a virtual machine operating via the virtual machine monitor. In some embodiments, the virtual machine may support and operate one or more services, such as virtual networking functions (VNFs) which may provide networking services.

Embodiments may also include using the communicated packets to determine latency and jitter for virtual machine monitor. For example, the latency may be based a difference between when a packet was sent by a network interface and when it was received by another network interface. The measurements make indicate the latency caused by the virtual machine monitor. The jitter or packet delay variation may also be calculated and based on the latency and historical latency measurements for the virtual machine monitor. The jitter may indicate variation of latency between different latency calculations.

In some instances, embodiments may also include performing a corrective action based on the latency or jitter not meeting a specified requirement or defined parameter for the virtual machine. For example, a service level agreement may stipulate one or more defined parameters including latency and jitter requirements for the virtual machine. Embodiments may include ensuring that these requirements are being met by the virtual machine monitor and taking mitigating or corrective actions when they are not being met. For example, a virtual machine and applications may be migrated to a different virtual machine monitor. In another examples, embodiments may include initiating a virtual machine and applications on a different virtual machine monitor. These and other details will be discussed in the following description.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

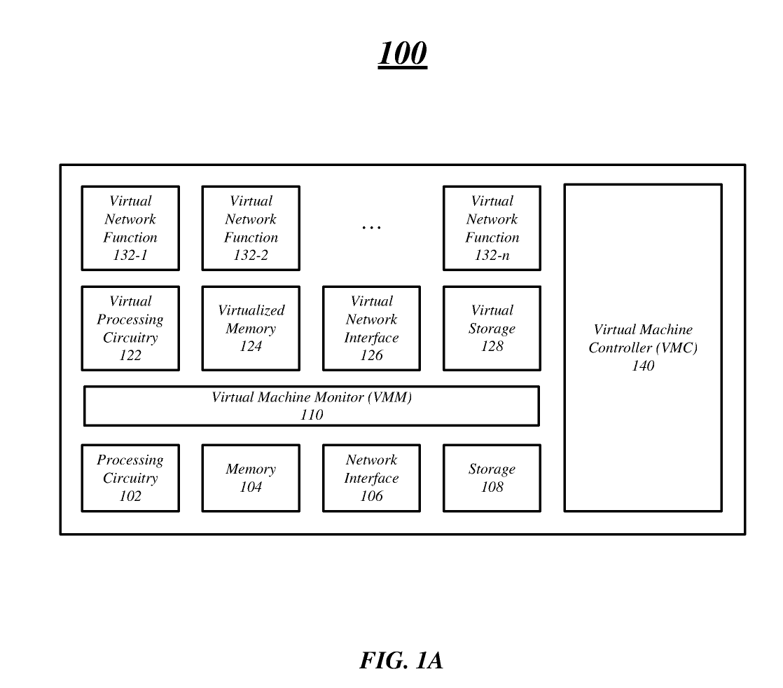

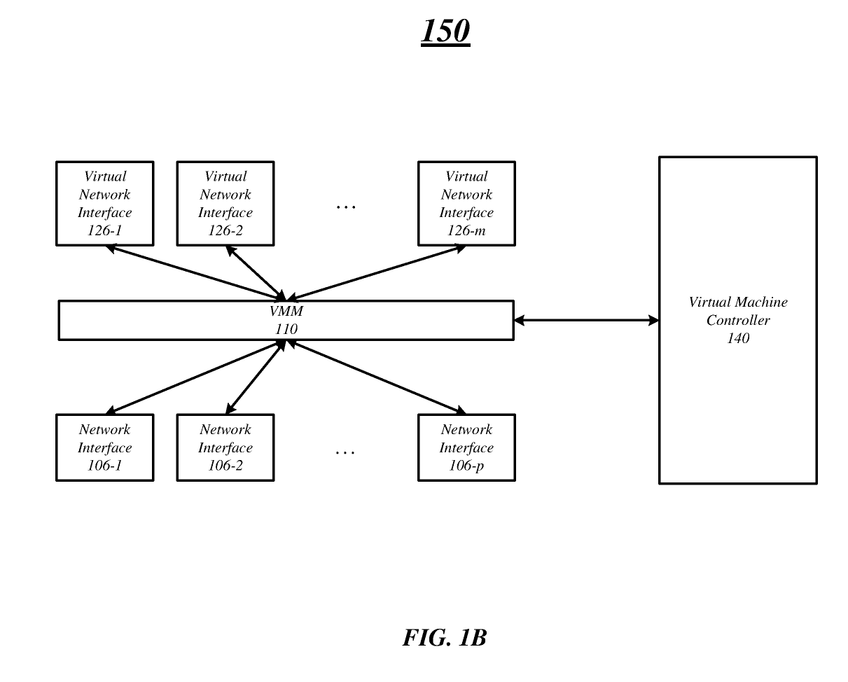

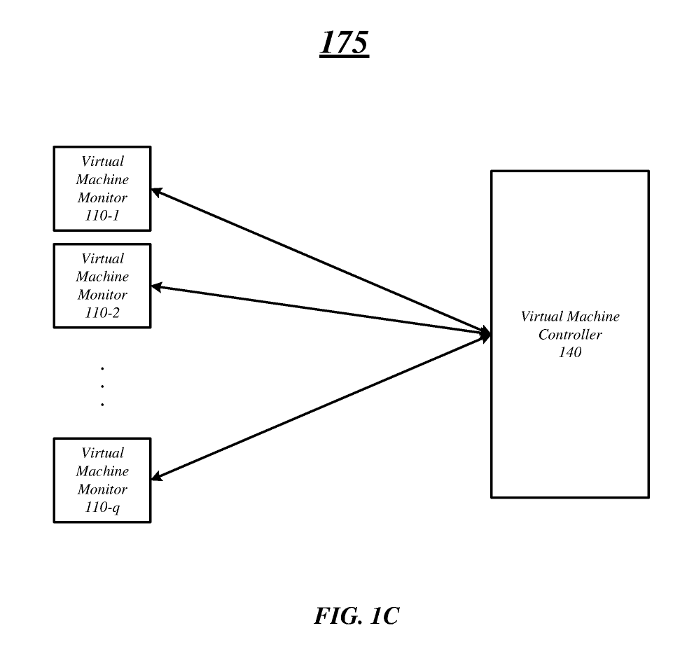

FIG. 1A illustrates a general overview of a system 100 which may be part of a virtual environment. In embodiments, the system 100 depicted in some of the figures may be provided in various configurations. In some embodiments, the systems may be configured as a distributed system where one or more components of the system are distributed across one or more networks in a cloud computing system. Further, the systems may utilize virtual environments. Thus, one or more components of the systems may not necessarily be tied to a particular machine or device, but may operate on a pool or grouping of machines or devices having available resources to meet particular performance requirements, for example. System 100 may enable one or more virtual environments to meet one or more service level defined parameters. These and other details will become more apparent in the following description.

System 100 may include processing circuitry 102, memory 104, one or more network interfaces 106, and storage 108. In some embodiments, the processing circuitry 102 may include logic and may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, a field-programmable gate array (FPGA) circuit, or any other type of processor or processing circuit on a single chip or integrated circuit. The processing circuitry 102 may be connected to and communicate with the other elements of the peer system 105 via interconnects (now shown), such as one or more buses, control lines, and data lines. In some embodiments, the processing circuitry 102 may include processor registers or a small amount of storage available the processing units to store information including instructions that and can be accessed during execution. Moreover, processor registers are normally at the top of the memory hierarchy, and provide the fastest way to access data.

As mentioned, the system 100 may include memory 104 to store information. Further, memory 104 may be implemented using any machine-readable or computer-readable media capable of storing data, including both volatile and non-volatile memory. In some embodiments, the machine-readable or computer-readable medium may include a non-transitory medium. The embodiments are not limited in this context.

The memory 104 can store data momentarily, temporarily, or permanently. The memory 104 stores instructions and data for the system 100. The memory 104 may also store temporary variables or other intermediate information while the processing circuitry 102 is executing instructions. In some embodiments, information and data may be loaded from memory 104 into the computing registers during processing of instructions. Manipulated data is then often stored back in memory 104, either by the same instruction or a subsequent one. The memory 104 is not limited to storing the above discussed data; the memory 104 may store any type of data.

The one or more network interfaces 106 includes any device and circuitry for processing information or communications over wireless and wired connections. For example, the one or more network interfaces 106 may include a receiver, a transmitter, one or more antennas, and one or more Ethernet connections. The specific design and implementation of the one or more network interfaces 106 may be dependent upon the communications network in which the system 100 intended to operate.

The system 100 may include storage 108 which may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 108 may include technology to increase the storage performance enhanced protection for valuable digital media when multiple hard drives are included, for example. Further examples of storage 108 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

Further, the storage 108 may include instructions that may cause information to be temporarily stored in memory 104 and processed by processing circuitry 102. More specifically, the storage 108 may include one or more operating systems (OS), one or more virtual environments, and one or more applications.

In embodiments, the one or more operating systems, may be any type of operating system such as Android® based on operating system, Apple iOS® based operating system, Symbian® based operating system, Blackberry OS® based operating system, Windows OS® based operating system, Palm OS® based operating system, Linux® based operating system, FreeBSD® based operating system, and so forth. The operating system may enable other virtual environments and applications to operate.

In some embodiments, the system 100 may include one or more virtual environments which may include one or more virtual machines that operate via a virtual machine monitor 110, such as hypervisor. These virtual machines may emulate particular parts of a computer system, such as hardware, memory, and interfaces, and software including an operating system. For example and as will be discussed in more detail below, the system 100 may include virtual processing circuitry 122, virtualized memory 124, one or more virtual network interfaces 126, and virtual storage 128.

In some embodiments, the virtual processing circuitry 122 which may be a physical central processing unit (CPU), such as processing circuitry 102, which is assigned to a virtual machine. In some instances, each virtual machine may be allocated virtual processing circuitry 122. In some instances, if the system 100 has multiple CPU cores at its disposal, however, then a computer processing unit (CPU) scheduler can assign execution contexts and the virtual processing circuitry 122 enables processing via a series of time slots on logical processors. Embodiments are not limited in this manner.

In a similar manner, the system 100 may include virtualized memory 124 which may include a portion of the memory 104 allocated for a virtual machine. The virtualized memory 124 may be used by the virtual machine in a same manner as memory 104 is used. For example, the virtualized memory 124 may store instructions associated with the virtual machine for processing. In some embodiments, the virtualized memory 124 may be controlled by a virtual memory manager (not shown), which may be part of the virtual machine monitor 110.

The system 100 may also include one or more virtual network interfaces 126. A virtual network interface 126 is an abstract virtualized representation of a computer network interface, such as network interface 106. A virtual network interface 126 may appear to a virtual machines as a full-fledged Ethernet controller having its own media access control (MAC) address. A virtual network interface 126 may be bridged to a network interface 106. Packets communicated by a virtual machine may be sent through the virtual network interface(s) 126 and a bridged physical network interface(s) 106 for communication to a destination, for example. In some embodiments, packets may be communicated through the virtual machine monitor 110.

The system 100 may also include virtual storage 128. The virtual storage 128 may be a portion of the physical storage 108 allocated to a virtual machine, for example. The virtual storage 128 may store information for a virtual machine. In some instances, the virtual storage 128 may be allocated to a virtual machine at the time of creation of the virtual machine.

In some instances, the system 100 can include and/or utilize virtual network functions (VNFs) 132-n which takes on the responsibility of handling specific network functions that run on one or more virtual machines, for example, on top of the hardware networking infrastructure—routers, switches, etc. Individual VNFs can be connected or combined together as building blocks to offer a full-scale networking communication services for the system 100. For example, in some embodiments, system 100 may be part of a Telco system for processing cellular and packet based communications in Long-Term Evolution (LTE) and subsequent 5G standards systems. The various VNFs 132-n may provide various communication capabilities for the system 100. Thus, the VNFs 132-n may be expected to have stringent performance requirements based on traffic classes and defined by service level agreements. As will be discussed in more detail, embodiments are directed towards maintaining these stringent performance requirements by monitoring packet communication through the virtual machine monitor 110 to determine real-time, average, and mean latency and jitter at least partially caused by the virtual environment and virtual machine monitor 110.

The virtual machine monitor 110 or hypervisor may be a piece of computer software, firmware hardware that creates and runs virtual machines. In some instances, the virtual machine monitor 110 presents the virtual circuitry 122, virtualized memory 124, virtual network interfaces 126, and virtual storage 128 to a virtual machine for use. Thus, the virtual machine monitor 110 may enable a virtual machine to utilize hardware and components of the system 100. For example, the virtual machine monitor 110 enable an application running in a virtual machine environment to utilize the processing circuitry 102 via the virtual processing circuitry 122, the memory 104 via the virtualized memory 124, and storage 108 via the virtual storage 128. Similarly, the virtual machine monitor 110 may enable packets to be communicated between applications of a virtual machine and an outside compute environment via the virtual network interface 126 and a network interface 106. These packets may be communicated to one or more other devices via wired or wireless connections. In some embodiments, the virtual machine monitor 110 may present a guest operating system with a virtual operating platform to a virtual machine and manages the execution of the guest operating system.

As previously mentioned, embodiments may include monitoring latency and jitter of packets through the virtual machine monitor 110. For example, one or more packets, such as tracer packets, may be communicated between each of the network interfaces 106 and each of the virtual network interfaces 126. The packets are generated by the network interfaces 106 and virtual network interfaces 126 hosted by the virtual machine monitor 110 and communicated on a periodic, or a semi-periodic basis. More specifically, the packets may be injected by the network interfaces 106 and the virtual network interfaces 126 on a fixed inter frame delay (period) to allow ease of latency and jitter detection. Further, various injection path granularities may be supported including at the virtual machine level, the virtual port/virtual bridge level, the virtual connection level, and the class of service level. The class of service level may be the traffic class, such as real-time traffic and best effort traffic. The virtual machine monitor 110 may determine the instantaneous latency and jitter between the network interfaces 106 and the virtual network interfaces 126 based on the communication of the packets. Further, the virtual machine monitor 110 may communicate this information, e.g. instantaneous latency and jitter information, to the virtual machine controller 140 for further processing.

In embodiments, the system 100 may also include a virtual machine controller 140, such as VMware® Orchestrator® or OpenStack®. The virtual machine controller 140 may enable a user to perform administrative tasks for one or more virtual machines. Further, the virtual machine controller 140 may receive latency and jitter information from one or more virtual machine monitors 110 to generate and update latency and jitter distribution models across a cloud compute environment. Thus, the virtual machine controller 140 can monitor latency and jitter at the cloud level and make real-time decisions as to whether specific service level agreements are being met for various users and user applications. For example, the virtual machine controller 140 may determine whether a virtual machine monitor 110 and associated virtual machines are capable of meeting the defined parameters including latency and jitter requirements based on a service level agreement. If not, the virtual machine controller 140 may cause one or more mitigating or corrective actions to be performed. For example, if applications are already operating on a system that is not supporting specified latency and jitter requirements, the virtual machine controller 140 may cause a virtual machine and the applications, such as VNFs 132-n, to migrate to a different virtual machine monitor 110 that is capable of the meeting the requirements. In a different example, the virtual machine controller 140 may cause a virtual machine and applications that is not currently running, to initiate on a virtual machine monitor 110 that is capable of meeting specified requirements. In another example, the virtual machine controller 140 may cause one or more configuration changes in a virtual machine monitor 110 to improve performance characteristics. Embodiments are not limited to these examples.

FIG. 1B illustrates an example of a system 150 for monitoring and mitigating latency and jitter for a cloud based compute environment. As previously mentioned, embodiments may include each network interface 106-p and virtual network interface 126-m, where p and m may be any positive integer, communicating packets between each other. Thus, packets may be transmitted to and from all of the interfaces (106 and 126) at intermittent intervals. These network interfaces 106 and virtual network interfaces 126 may provide network services for a virtual machine supported by the virtual machine monitor 110. The virtual machine monitor 110 may determine an instantaneous latency and jitter based on the packets communicated between the network interfaces 106 and the virtual network interfaces 126.

The packets may be inserted into the system 150 during “active sessions,” e.g. when the system 150 is processing information for an application, such as a VNF(s) 132, to enable network function virtualization (NFV). Thus, packets may be inserted into real paths through the processing circuitry 102 to accurately reflect paths traversed by session packets. Thus, in a NFV environment including the VNFs 132, the virtual machine monitor 110 may treat the packets, e.g. tracer packets, as real-traffic. However, the packets may be removed before a final stage of the virtual network interfaces 126 before delivery to an application or passed through to an application. In some instances, the packets may be removed before exiting the processing circuitry 102. Thus, the tracing is non-intrusive from a performance perspective as the packet scheduling ensures that the periodic packet insertion can be scheduled across the network interfaces 106 and virtual network interfaces 126 such that they do not impact throughput. For example, a packet scheduler causes communication of the tracing packets during periods or intervals in which it knows that session packets are not communicating. Embodiments are not limited in this manner.

The virtual machine monitor 110 may determine latency and jitter information and sends it to the virtual machine controller 140. The virtual machine monitor 110 also monitors and keeps track of packet drops, which may also be sent to the virtual machine controller 140 and used to perform corrective actions. In some embodiments, the virtual machine monitor 110 may communicate the information to the virtual machine controller 140 based on a triggering event. For example, the information may be communicated when an instantaneous latency is above latency threshold. The latency threshold may be based on a latency requirement established in a service level agreement, for example. In another example, the virtual machine monitor 110 may communicate information when an average latency is determined to be above a threshold value, such as a latency threshold value that may also be based on a latency requirement in a service level agreement. Embodiments are not limited in this manner, and in some instances, the virtual machine controller 140 may poll for the information on a periodic, semi-periodic, or non-periodic basis. In some instances, the virtual machine controller 140 may monitor and make determinations for any number of virtual machines in a cloud based compute environment.

FIG. 1C illustrates an example system 175 for monitoring and mitigating latency and jitter in cloud based compute environment. The system 175 includes a number of virtual machine monitors 110-q, where q may be any positive integer, that can be monitored by a virtual machine controller 140. The virtual machine controller 140 is not limited to monitoring the virtual machine monitors 110-q and may perform other actions, as will be discussed in more detail below.

Each of the virtual machine monitors 110-q may be associated with a virtual environment or virtual machine to provide a virtual environment. For example, a virtual machine monitor 110 may support a virtual machine to enable network function virtualization and include VNFs 132 applications. These VNFs 132 application typically include stringent latency and jitter requirements. Each of the virtual machine monitors 110-q may report latency and jitter information to the virtual machine controller 140 which ensures that the latency and jitter requirements for the applications, such as VNFs 132, are being met. The virtual machine controller 140 may move applications and a virtual machine to a different virtual machine monitor 110 if the requirements are not being met, for example. Note that each of the virtual machine monitors 110-q and the virtual machine controller 140 may operate a single compute device or server or across multiple compute devices or servers. Thus, moving the applications and virtual machine may include moving them from one device to another device. However, embodiments are not limited in this manner. In some instances, the applications and virtual machine may be moved between virtual machine monitors 110 on the same device.

In some embodiments, the virtual machine controller 140 may receive latency and jitter information from each of the virtual machine monitors 110-q and generate statistical models for each of the virtual machine monitors 110-q. The statistical models may keep track of latency and jitter statistics for each of the virtual machine monitors 110-q over a period of time. The models may include a Gaussian distribution that can be used to determine a mean and standard deviation with respect to latency and jitter for each of the virtual machine monitors. These models may be used by the virtual machine controller 140 to determine whether a particular virtual machine monitor 110-q can meet the requirements of a virtual machine and applications. If the particular virtual machine monitor 110-q can support a virtual machine and applications based on the models, the virtual machine controller 140 may not take corrective actions. However, if the particular virtual machine monitor 110-q cannot support the virtual machine and applications, the virtual machine controller 140 may move or instantiate the virtual machine and applications on a different virtual machine monitor 110-q.

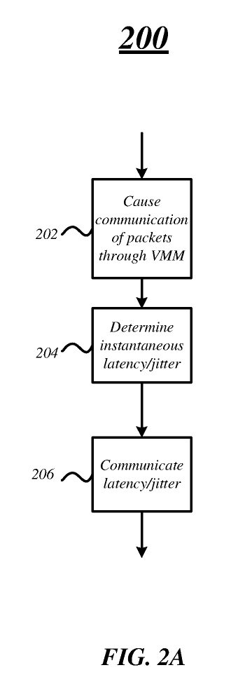

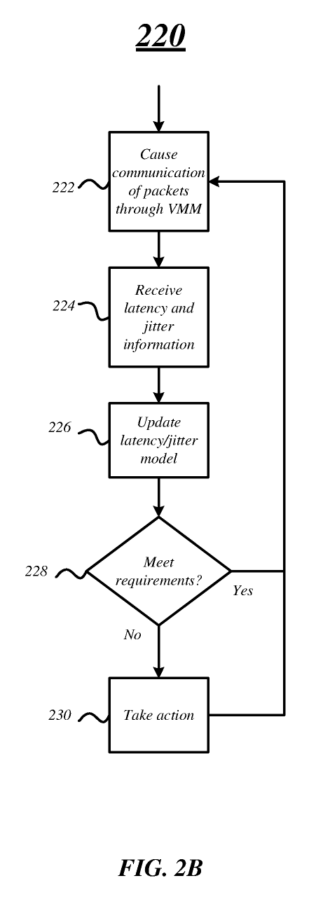

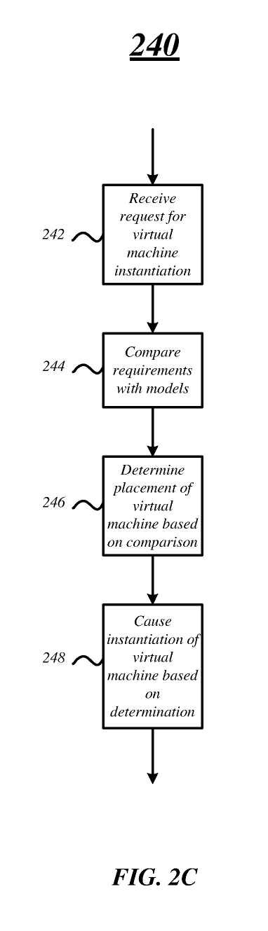

FIG. 2A illustrates an example of a first logic flow 200 for processing in a virtual environment. The logic flow 200 may be representative of some or all of the operations executed by one or more embodiments described herein. For example, the logic flow 200 may illustrate operations performed by a virtual machine monitor 110 illustrated in FIGS. 1A-1C. Various embodiments are not limited in this manner and one or more operations may be performed by other components including a virtual machine controller 140.

At block 202, a virtual machine monitor may cause one or more network interfaces and virtual network interfaces to communicate packets between each other. In some embodiments, the packets may be tracer packets inserted into an active session representing real paths through the processing circuitry of a system. The active session may be a session where information to be or being processed by one or more applications is also communicated between a virtual machine and client devices. For example, during an active session one or more active session packets relating to telecom communications may also be communicated between the network interfaces and virtual network interfaces. These active session packets may include information that is processed by applications, such as VNFs.

In embodiments, tracer packets do not interfere with the active session packets having information processed by applications. For instance, the tracer packets may be communicated between active session packet communications. However, the tracer packets may follow the same paths as the active session packets through the processing circuitry, but may be removed before exiting the processing circuitry. The tracer packets may also be removed at different points of the communications pipeline. For example, they may also be stripped by a final stage of a virtual network interface before delivery to an application.

The tracer packets also may be communicated periodically or semi-periodic such that they do not interfere with the active session packets. For example, the tracer packets may be communicated with a fixed inter frame delay (period). Thus, the tracer packets will not impact throughput of the active session packets.

In embodiments, each network interface and each virtual network interface may communicate a tracer packet to every other network interface and virtual network interface. Further and at block 204, the virtual machine monitor may determine an instantaneous latency and jitter based on the communication of the tracer packets. The virtual machine monitor may determine the instantaneous latency and jitter after each time the network interfaces and virtual network interfaces communicate the tracer packets. The latency may be determined based on a difference between when a tracer packet was communicated by an interface and when it was received by an interface. In some embodiments, the virtual machine monitor may receive this information from the interfaces. Further, the virtual machine monitor may determine the instantaneous latency based on the communication of a single tracer packet, multiple tracer packets, and all tracker packets communicated during an inter frame period. Jitter may also be determined and based on these tracer packets communicated during the inter frame period.

At block 206, the virtual machine monitor may communicate the instantaneous latency and jitter to a virtual machine controller. In some embodiments, the virtual machine monitor may communicate the latency and jitter information when the latency and jitter requirements are not being met by the virtual machine monitor. As previously mentioned, these requirements may be based on a service level agreement defining performance requirements for one or more applications supported by the virtual machine monitor. Embodiments are not limited in this manner. For example, the virtual machine monitor may communicate the latency and jitter information after each determination and/or inter frame period.

FIG. 2B illustrates an example of a second logic flow 220 for processing in a virtual environment. The logic flow 220 may be representative of some or all of the operations executed by one or more embodiments described herein. For example, the logic flow 220 may illustrate operations performed by a virtual machine controller illustrated in FIGS. 1A-1C. Various embodiments are not limited in this manner. Various embodiments are not limited and one or more operations may be performed by other components including a virtual machine monitor.

At block 222, the virtual machine controller may cause one or more packets, such as tracer packets, to be communicated by network interfaces and virtual network interfaces for one or more virtual machine monitors. For example, the virtual machine controller may include a scheduler (not shown) to determine when interfaces for each of one or more virtual machine monitors are to communicate the tracer packets such that they do not interfere with active session packets.

At block 224, the virtual machine controller may receive latency and jitter information from a virtual machine monitor. Note that the virtual machine controller receives latency and jitter information from each of the virtual machine monitors within the virtual environment the virtual machine controller is controlling. However, the information can be received at different times or intervals based on the scheduling of communication of the tracer packets for each of the virtual machine monitors. The latency and jitter information may be the instantaneous latency and jitter determined by the virtual machine monitor based on communication of tracer packets during a single or multiple inter frame periods.

At block 226, the virtual machine controller may update latency and jitter models which may include latency and jitter statistics over a period of time for each of the virtual machine monitors. For example, a latency and jitter model may indicate an average latency over a period of time for a virtual machine monitor, a peak latency for a virtual machine monitor, a time associated with the peak latency, and so forth. This information and the instantaneous latency and jitter may be used to determine whether latency and jitter requirements are being met for each of the applications hosted by virtual machines and virtual machine monitors at block 228. If the requirements are being met, the virtual machine controller may continue to monitor and update the models for the virtual machine monitors.

At block 230, the virtual machine controller may take corrective action to ensure that latency and jitter requirements are being met for one or more applications. For example, the virtual machine controller may migrate a virtual machine and applications from a virtual machine monitor failing to meet the requirements to a virtual machine monitor that will meet the requirements. In some instances, the virtual machine controller may choose which virtual machine monitor to move the virtual machine and applications based on the latency and jitter models and/or instantaneous latency and jitter information. In some embodiments, the action performed by the virtual machine controller may include determining where to instantiate a virtual machine, as will be discussed in more detail below in FIG. 2C.

FIG. 2C illustrates an example of a third logic flow 240 for processing in a virtual environment. The logic flow 240 may be representative of some or all of the operations executed by one or more embodiments described herein. For example, the logic flow 240 may illustrate operations performed by a virtual machine controller 140 illustrated in FIGS. 1A-1C. Various embodiments are not limited in this manner. Various embodiments are not limited and one or more operations may be performed by other components including a virtual machine monitor 110.

At block 242, the virtual machine controller may receive a request to instantiate a virtual machine including one or more applications for processing information. In some embodiments, the request may be user generated and based on a user interaction with a user input. However, embodiments are not limited in this manner and in some instances, the request may be computer generated.

At block 244, the virtual machine controller may compare the requirements for the virtual machine and applications with the latency and jitter models for the virtual machine monitors. The comparison may be used to determine which virtual machine monitor to instantiate the virtual machine and applications on at block 246. For example, the virtual machine controller may choose an available virtual machine monitor capable of meeting the latency and jitter requirements for the virtual machine and applications. In some instances, the “best” or virtual machine monitor with the lowest latency based on the models may be chosen. Although, embodiments are not limited in this manner. Further and at block 248, the virtual machine controller may cause the virtual machine and applications to instantiate on the chosen virtual machine monitor.

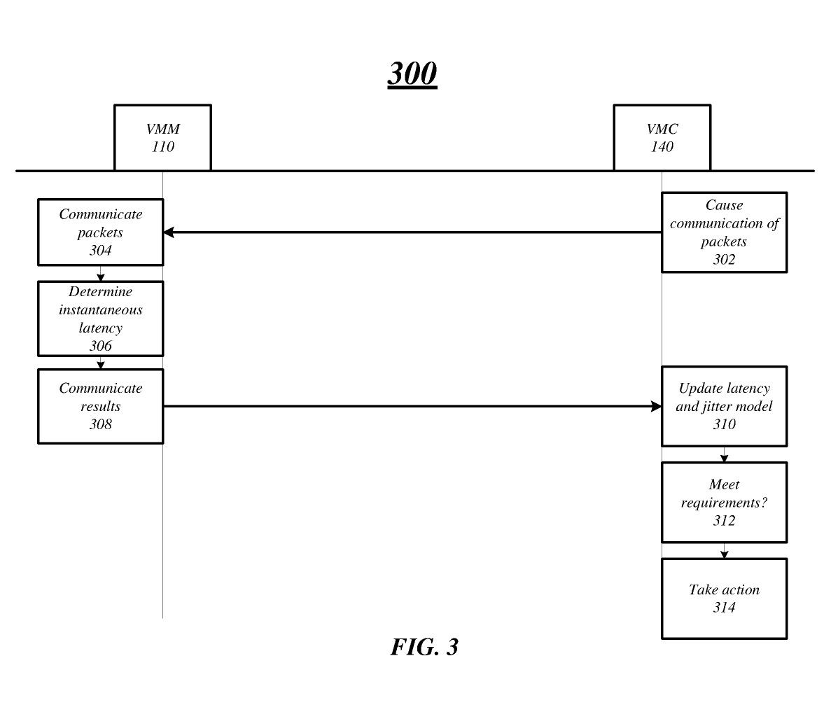

FIG. 3 illustrates an example of a first processing flow 300 for processing in a virtual environment including monitoring latency and jitter. The processing flow 300 may be representative of some or all of the operations executed by one or more embodiments described herein. For example, the processing flow 300 may illustrate operations performed by a virtual machine controller and virtual machine monitor illustrated in FIGS. 1A-1C. Although certain operations are illustrated as in occurring a particular order, embodiments are not limited in this manner. One or more operations may occur before, during, or after other operations.

At block 302, embodiments include a virtual machine controller 140 causing communication of one or more packets, such as tracer packets, to be communicated by interfaces associated with a virtual machine monitor 110. For example, the virtual machine controller 140 may schedule communication of the tracers packets to be communicated via the interfaces. At block 304, the virtual machine monitor 110 may communicate or cause communication of the one or more tracer packets. More specifically, the virtual machine monitor 110 may cause each of network interfaces and virtual network interfaces to communicate tracer packets to each other.

In embodiments, the virtual machine monitor 110 may determine the instantaneous latency and jitter based on the tracer packets at block 306. Further and at block 308, the virtual machine monitor may communicate the results in latency and jitter information to the virtual machine coordinate 140. The results may be communicated as one or more packets via one or more wired or wireless communication links, for example.

At block 310, the virtual machine controller 140 may update a latency and jitter model based on the results and latency and jitter information. Further and at block 312, the virtual machine controller 140 determines whether the virtual machine monitor 110 operating a virtual machine and one or more applications is meeting and/or exceeding the latency and jitter requirements for the virtual machine and applications. If the virtual machine monitor 110 is meeting the requirements, the virtual machine controller 140 may take no action. However and at block 314, if the virtual machine monitor 110 is not providing or supporting the requirements for the virtual machine and applications the virtual machine controller 140 may take an action. For example, the virtual machine controller 140 may cause a virtual machine and applications to migrate to a different virtual machine monitor 110 capable of support the requirements. In another example, the virtual machine controller 140 may initiate a virtual machine and applications on a different virtual machine monitor 110 based on the results. Embodiments are not limited in this manner and other actions may be performed. For example, a user notification may be communicated to a user, which may be in the form of an alert message.

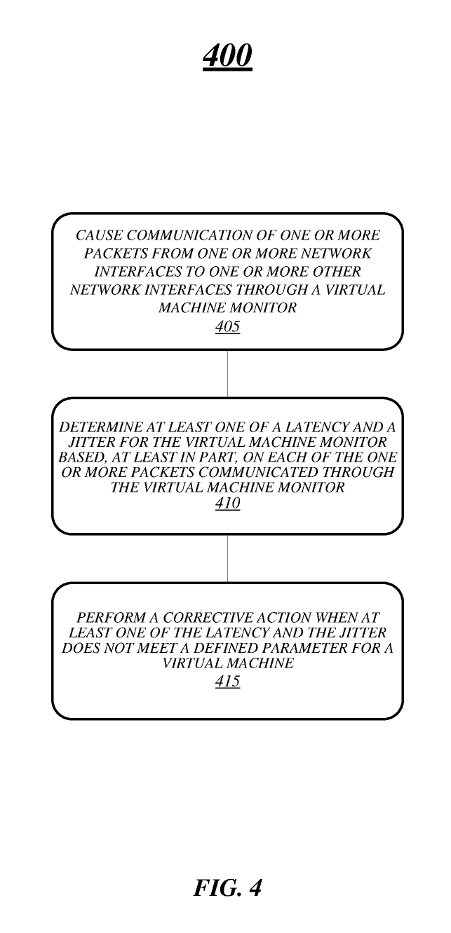

FIG. 4 illustrates an embodiment of a fourth logic flow diagram 400. The logic flow 400 may be representative of some or all of the operations executed by one or more embodiments described herein. For example, the logic flow 400 may illustrate operations performed by one or more systems or devices in FIGS. 1A-1C. Various embodiments are not limited in this manner.

In various embodiments, logic flow 400 may include causing communication one or more packets from one or more network interfaces to one or more other network interfaces through a virtual machine monitor at block 405. For example, a scheduler may cause one or more tracer packets to be communicated between each network interface and virtual network interface associated with a virtual machine operating via the virtual machine monitor. In some embodiments, the virtual machine may support and operate one or more applications, such as VNFs.

At block 410, the logic flow 400 may include determining at least one of a latency and a jitter for the virtual machine monitor based, at least in part, on each of the one or more packets communicated through the virtual machine monitor. For example, a virtual machine controller may receive latency and jitter information based on the communication of the packets to determine the latency for a virtual machine monitor.

At block 415, the logic flow includes performing a corrective action when at least one of the latency and the jitter does not meet a defined parameter for a virtual machine on the virtual machine monitor. For example, a service level agreement may stipulate one or more defined parameters including latency and jitter requirements for the virtual machine. Embodiments may include ensuring that these requirements are being met by the virtual machine monitor and taking mitigating or corrective actions when they are not being met. For example, a virtual machine and applications may be migrated to a different virtual machine monitor. In another examples, embodiments may include initiating a virtual machine and applications on a different virtual machine monitor. Embodiments are not limited to these examples.

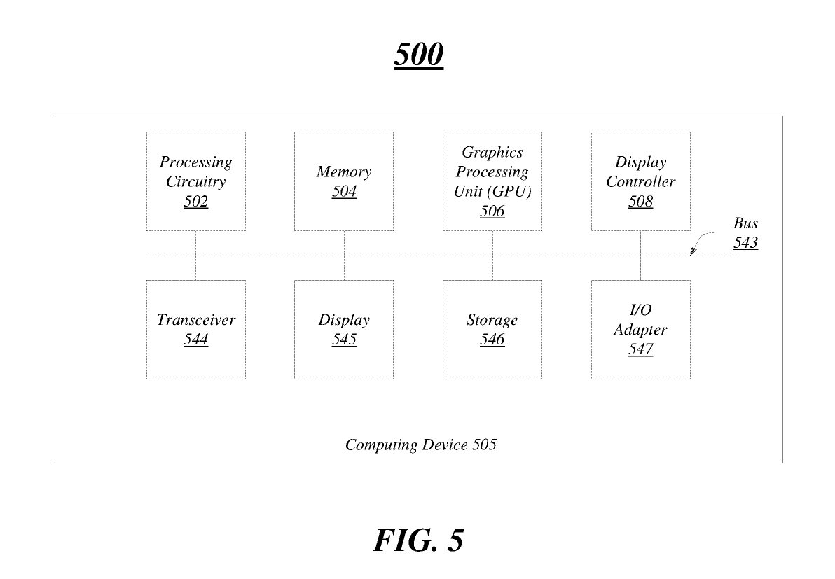

FIG. 5 illustrates one embodiment of a system 500. In various embodiments, system 500 may be representative of a system or architecture suitable for use with one or more embodiments described herein, such as systems and devices illustrated in FIGS. 1A-1C. The embodiments are not limited in this respect.

As shown in FIG. 5, system 500 may include multiple elements. One or more elements may be implemented using one or more circuits, components, registers, processors, software subroutines, modules, or any combination thereof, as desired for a given set of design or performance constraints. Although FIG. 5 shows a limited number of elements in a certain topology by way of example, it can be appreciated that more or less elements in any suitable topology may be used in system 500 as desired for a given implementation. The embodiments are not limited in this context.

In various embodiments, system 500 may include a computing device 505 which may be any type of computer or processing device including a personal computer, desktop computer, tablet computer, netbook computer, notebook computer, laptop computer, server, server farm, blade server, or any other type of server, and so forth.

In various embodiments, computing device 505 may include processor circuit 502. Processor circuit 502 may be implemented using any processor or logic device. The processing circuit 502 may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. The processing circuit 502 may be connected to and communicate with the other elements of the computing system via an interconnect 543, such as one or more buses, control lines, and data lines.

In one embodiment, computing device 505 may include a memory unit 504 to couple to processor circuit 502. Memory unit 504 may be coupled to processor circuit 502 via communications bus 543, or by a dedicated communications bus between processor circuit 502 and memory unit 504, as desired for a given implementation. Memory unit 504 may be implemented using any machine-readable or computer-readable media capable of storing data, including both volatile and non-volatile memory. In some embodiments, the machine-readable or computer-readable medium may include a non-transitory medium. The embodiments are not limited in this context.

Computing device 505 may include a graphics processing unit (GPU) 506, in various embodiments. The GPU 506 may include any processing unit, logic or circuitry optimized to perform graphics-related operations as well as the video decoder engines and the frame correlation engines. The GPU 506 may be used to render 2-dimensional (2-D) and/or 3-dimensional (3-D) images for various applications such as video games, graphics, computer-aided design (CAD), simulation and visualization tools, imaging, etc. Various embodiments are not limited in this manner; GPU 506 may process any type of graphics data such as pictures, videos, programs, animation, 3D, 2D, objects images and so forth.

In some embodiments, computing device 505 may include a display controller 508. Display controller 508 may be any type of processor, controller, circuit, logic, and so forth for processing graphics information and displaying the graphics information. The display controller 508 may receive or retrieve graphics information from one or more buffers. After processing the information, the display controller 508 may send the graphics information to a display.

In various embodiments, system 500 may include a transceiver 544. Transceiver 544 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. It may also include a transceiver for wired networking which may include (but are not limited to) Ethernet, Packet Optical Networks, (data center) network fabric, etc. In communicating across such networks, transceiver 544 may operate in accordance with one or more applicable standards in any version. The embodiments are not limited in this context.

In various embodiments, computing device 505 may include a display 545. Display 545 may constitute any display device capable of displaying information received from processor circuit 502, graphics processing unit 506 and display controller 508.

In various embodiments, computing device 505 may include storage 546. Storage 546 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 546 may include technology to increase the storage performance enhanced protection for valuable digital media when multiple hard drives are included, for example. Further examples of storage 546 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, computing device 505 may include one or more I/O adapters 547. Examples of I/O adapters 547 may include Universal Serial Bus (USB) ports/adapters, IEEE 1394 Firewire ports/adapters, and so forth. The embodiments are not limited in this context.

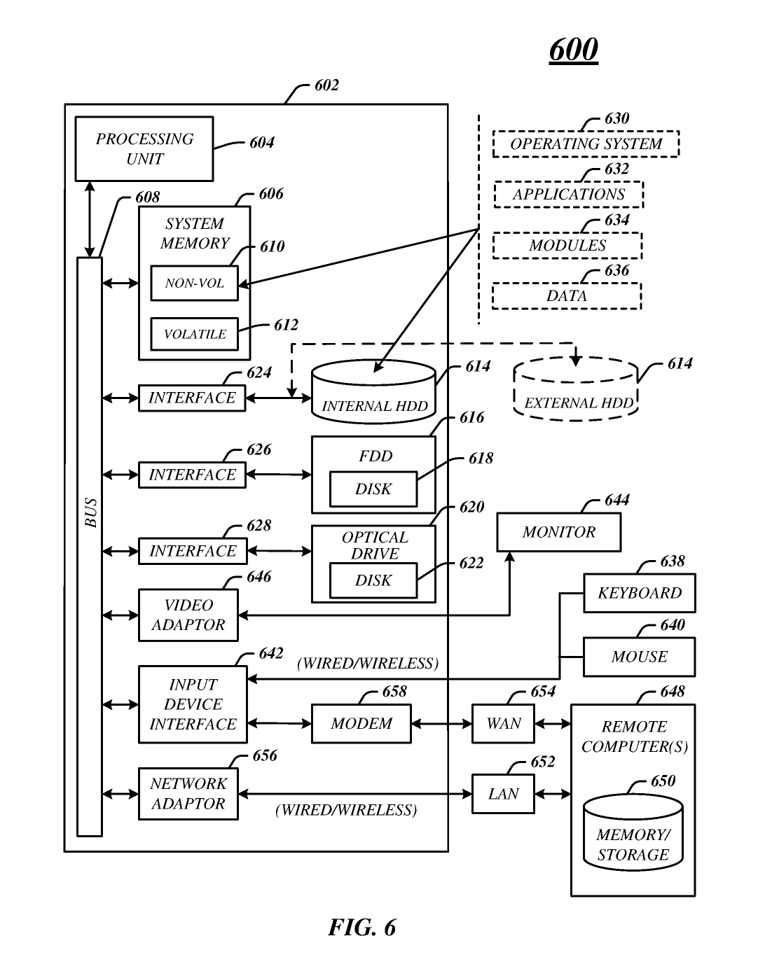

FIG. 6 illustrates an embodiment of an exemplary computing architecture 600 suitable for implementing various embodiments as previously described. In one embodiment, the computing architecture 600 may comprise or be implemented as part one or more systems and devices previously discussed.

As used in this application, the terms “system” and “component” are intended to refer to a computer-related entity, either hardware, a combination of hardware and software, software, or software in execution, examples of which are provided by the exemplary computing architecture 600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 600.

As shown in FIG. 6, the computing architecture 600 comprises a processing unit 604, a system memory 606 and a system bus 608. The processing unit 604 can be any of various commercially available processors, such as those described with reference to the processing circuitry shown in FIG. 1A.

The system bus 608 provides an interface for system components including, but not limited to, the system memory 606 to the processing unit 604. The system bus 608 can be any of several types of bus structure that may further interconnect to a memory bus (with or without a memory controller), a peripheral bus, and a local bus using any of a variety of commercially available bus architectures. Interface adapters may connect to the system bus 608 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 600 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 606 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 6, the system memory 606 can include non-volatile memory 610 and/or volatile memory 612. A basic input/output system (BIOS) can be stored in the non-volatile memory 610.

The computer 602 may include various types of computer-readable storage media in the form of one or more lower speed memory units, including an internal (or external) hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs 632, other program modules 634, and program data 636. In one embodiment, the one or more application programs 632, other program modules 634, and program data 636 can include, for example, the various applications and/or components of the system 105.

A user can enter commands and information into the computer 602 through one or more wired/wireless input devices, for example, a keyboard 638 and a pointing device, such as a mouse 640. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 604 through an input device interface 642 that is coupled to the system bus 608, but can be connected by other interfaces such as a parallel port, IEEE 1394 serial port, a game port, a USB port, an IR interface, and so forth.

A monitor 644 or other type of display device is also connected to the system bus 608 via an interface, such as a video adaptor 646. The monitor 644 may be internal or external to the computer 602. In addition to the monitor 644, a computer typically includes other peripheral output devices, such as speakers, printers, and so forth.

The computer 602 may operate in a networked environment using logical connections via wired and/or wireless communications to one or more remote computers, such as a remote computer 648. The remote computer 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wired/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax, and Bluetooth™ wireless technologies, 3G, 4G, LTE wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet, and to wire networks (which use IEEE 802.3-related media and functions).

The various elements and components as previously described with reference to FIGS. 1-5 may comprise various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The detailed disclosure now turns to providing examples that pertain to further embodiments. Examples one through thirty-two (1-32) provided below are intended to be exemplary and non-limiting.

In a first example, a system, device, apparatus may include one or more networking interfaces memory, processing circuitry coupled with the memory; and logic, at least partially implemented by the processing circuitry. The logic to cause communication of one or more packets from one or more network interfaces through a virtual machine monitor, determine latency or jitter for the virtual machine monitor based, at least in part, on the one or more packets communicated through the virtual machine monitor, and perform a corrective action when the latency or the jitter does not meet a defined parameter for a virtual machine on the virtual machine monitor.

In a second example and in furtherance of the first example, a system, device, apparatus may include the logic to move the virtual machine on the virtual machine monitor to a different virtual machine monitor for the corrective action.

In a third example and in furtherance of any previous example, a system, device, apparatus may include the logic to initiate the virtual machine on a different virtual machine monitor for the corrective action.

In a fourth example and in furtherance of any previous example, a system, device, apparatus may include the defined parameter comprising one or more of a latency requirement and a jitter requirement specified in a service level agreement for the virtual machine.

In a fifth example and in furtherance of any previous example, a system, device, apparatus may include the logic to determine a latency and a jitter for each of a plurality of virtual machine monitors and generate a latency and jitter model based, at least in part, on the determined latencies and jitter.

In a sixth example and in furtherance of any previous example, a system, device, apparatus may include the logic to initiate the virtual machine on one of the plurality of virtual machine monitors based on the latency and jitter model and a service level agreement for the virtual machine.

In a seventh example and in furtherance of any previous example, a system, device, apparatus may include the logic to cause each network interface to communicate a packet to each other network interface through the virtual machine monitor to determine an instantaneous latency between the network interfaces.

In an eighth example and in furtherance of any previous example, a system, device, apparatus may include cause each network interface to communicate a packet to each other network interface through the virtual machine monitor on a periodic basis, determine an instantaneous latency after each communication, and update a latency and jitter model after each period using at least the instantaneous latency.

In a ninth example and in furtherance of any previous example, a system, device, apparatus may include wherein at least one of the network interfaces comprising a virtual network interface of a virtual machine supported by the virtual machine monitor.

In a tenth example and in furtherance of any previous example, a computer-readable storage medium comprising a plurality of instructions that, when executed by processing circuitry, enable processing circuitry to cause communication of one or more packets from one or more network interfaces to one or more other network interfaces through a virtual machine monitor, determine latency or jitter for the virtual machine monitor based, at least in part, on each of the one or more packets communicated through the virtual machine monitor, and perform a corrective action when the latency or the jitter does not meet a defined parameter for a virtual machine on the virtual machine monitor.

In an eleventh example and in furtherance of any previous example, a computer-readable storage medium comprising a plurality of instructions that, when executed by processing circuitry, enable processing circuitry to move the virtual machine on the virtual machine monitor to a different virtual machine monitor for the corrective action.

In a twelfth example and in furtherance of any previous example, a computer-readable storage medium comprising a plurality of instructions that, when executed by processing circuitry, enable processing circuitry to initiate the virtual machine on a different virtual machine monitor for the corrective action.

In a thirteenth example and in furtherance of any previous example, a computer-readable storage medium comprising a plurality of instructions having defined parameter comprising at least one of a latency requirement and a jitter requirement specified in a service level agreement for the virtual machine.

In a fourteenth example and in furtherance of any previous example, a computer-readable storage medium comprising a plurality of instructions that, when executed by processing circuitry, enable processing circuitry to determine a latency and jitter for each of a plurality of virtual machine monitors and generate a latency and jitter model based, at least in part, on the determined latencies.

In a fifteenth example and in furtherance of any previous example, a computer-readable storage medium comprising a plurality of instructions that, when executed by processing circuitry, enable processing circuitry to initiate the virtual machine on one of the plurality of virtual machine monitors based on the latency and jitter model and a service level agreement for the virtual machine.

In a sixteenth example and in furtherance of any previous example, a computer-readable storage medium comprising a plurality of instructions that, when executed by processing circuitry, enable processing circuitry to cause each network interface to communicate a packet to each other network interface through the virtual machine monitor to determine an instantaneous latency between the network interfaces.

In a seventeenth example and in furtherance of any previous example, a computer-readable storage medium comprising a plurality of instructions that, when executed by processing circuitry, enable processing circuitry to cause each network interface to communicate a packet to each other network interface through the virtual machine monitor on a periodic basis, determine an instantaneous latency after each communication, and update a latency and jitter model after each period using at least the instantaneous latency.

In an eighteenth example and in furtherance of any previous example, a computer-readable storage medium comprising a plurality of instructions that, when executed by processing circuitry, enable processing circuitry to include at least one of the network interfaces comprising a virtual network interface of a virtual machine supported by the virtual machine monitor.

In a nineteenth example and in furtherance of any previous example, a computer-implemented method may include causing communication of one or more packets from one or more network interfaces to one or more other network interfaces through a virtual machine monitor, determining latency or jitter for the virtual machine monitor based, at least in part, on each of the one or more packets communicated through the virtual machine monitor, and performing a corrective action when the latency or the jitter does not meet a defined parameter for a virtual machine on the virtual machine monitor.

In a twentieth example and in furtherance of any previous example, a computer-implemented method may include the corrective action comprising one or more of moving the virtual machine on the virtual machine monitor to a different virtual machine monitor, and initiating the virtual machine on a different virtual machine monitor for the corrective action.

In a twenty-first example and in furtherance of any previous example, a computer-implemented method may include the defined parameter comprising at least one of a latency requirement and a jitter requirement specified in a service level agreement for the virtual machine.

In a twenty-second example and in furtherance of any previous example, a computer-implemented method may include determining a latency and a jitter for each of a plurality of virtual machine monitors, and generating a latency and jitter model based, at least in part, on the determined latencies and jitter.

In a twenty-third example and in furtherance of any previous example, a computer-implemented method may include initiating the virtual machine on one of the plurality of virtual machine monitors based on the latency and jitter model and a service level agreement for the virtual machine.

In a twenty-fourth example and in furtherance of any previous example, a computer-implemented method may include causing each network interface to communicate a packet to each other network interface through the virtual machine monitor to determine an instantaneous latency between the network interface.

In a twenty-fifth example and in furtherance of any previous example, a computer-implemented method may include causing each network interface to communicate a packet to each other network interface through the virtual machine monitor on a periodic basis, determining an instantaneous latency after each communication, and updating a latency and jitter model after each period using at least the instantaneous latency.

In a twenty-sixth example and in furtherance of any previous example, a system and apparatus may include means for causing communication of one or more packets from one or more network interfaces to one or more other network interfaces through a virtual machine monitor, means for determining latency or jitter for the virtual machine monitor based, at least in part, on each of the one or more packets communicated through the virtual machine monitor, and means for performing a corrective action when the latency or the jitter does not meet a defined parameter for a virtual machine on the virtual machine monitor.

In a twenty-seventh example and in furtherance of any previous example, a system and apparatus include means for moving the virtual machine on the virtual machine monitor to a different virtual machine monitor, and means for initiating the virtual machine on a different virtual machine monitor for the corrective action.

In a twenty-ninth example and in furtherance of any previous example, an apparatus or system may include means for determining a latency and a jitter for each of a plurality of virtual machine monitors, and means for generating a latency and jitter model based, at least in part, on the determined latencies and jitter.

In a thirtieth example and in furtherance of any previous example, a system or apparatus may include means for initiating the virtual machine on one of the plurality of virtual machine monitors based on the latency and jitter model and a service level agreement for the virtual machine.

In a thirty-first example and in furtherance of any previous example, a system or an apparatus may include means for causing each network interface to communicate a packet to each other network interface through the virtual machine monitor to determine an instantaneous latency between the network interface.

In a thirty-second example and in furtherance of any previous example, a system or an apparatus including means for causing each network interface to communicate a packet to each other network interface through the virtual machine monitor on a periodic basis, means for determining an instantaneous latency after each communication, and means for updating a latency and jitter model after each period using at least the instantaneous latency.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
memory;
processing circuitry coupled with the memory; and
logic, at least partially implemented by the processing circuitry, the logic to:
cause communication of one or more packets from one or more network interfaces through a virtual machine monitor;
determine latency or jitter for the virtual machine monitor based, at least in part, on the one or more packets communicated through the virtual machine monitor; and
perform a corrective action when the latency or the jitter does not meet a defined parameter for a virtual machine on the virtual machine monitor.

2. The apparatus of claim 1, the logic to move the virtual machine on the virtual machine monitor to a different virtual machine monitor for the corrective action.

3. The apparatus of claim 1, the logic to initiate the virtual machine on a different virtual machine monitor for the corrective action.

4. The apparatus of claim 1, the defined parameter comprising one or more of a latency requirement and a jitter requirement specified in a service level agreement for the virtual machine.

5. The apparatus of claim 1, the logic to determine a latency and a jitter for each of a plurality of virtual machine monitors and generate a latency and jitter model based, at least in part, on the determined latencies and jitter.

6. The apparatus of claim 5, the logic to initiate the virtual machine on one of the plurality of virtual machine monitors based on the latency and jitter model and a service level agreement for the virtual machine.

7. The apparatus of claim 1, the logic to cause each network interface to communicate a packet to each other network interface through the virtual machine monitor to determine an instantaneous latency between the network interfaces.

8. The apparatus of claim 1, the logic to:
cause each network interface to communicate a packet to each other network interface through the virtual machine monitor on a periodic basis;
determine an instantaneous latency after each communication; and
update a latency and jitter model after each period using at least the instantaneous latency.

9. The apparatus of claim 1, wherein at least one of the network interfaces comprising a virtual network interface of a virtual machine supported by the virtual machine monitor.

10. A computer-readable storage medium comprising a plurality of instructions that, when executed by processing circuitry, enable processing circuitry to:
cause communication of one or more packets from one or more network interfaces to one or more other network interfaces through a virtual machine monitor;
determine latency or jitter for the virtual machine monitor based, at least in part, on each of the one or more packets communicated through the virtual machine monitor; and
perform a corrective action when the latency or the jitter does not meet a defined parameter for a virtual machine on the virtual machine monitor.

11. The computer-readable storage medium of claim 10, comprising a plurality of instructions, that when executed, enable processing circuitry to move the virtual machine on the virtual machine monitor to a different virtual machine monitor for the corrective action.

12. The computer-readable storage medium of claim 10, comprising a plurality of instructions, that when executed, enable processing circuitry to initiate the virtual machine on a different virtual machine monitor for the corrective action.

13. The computer-readable storage medium of claim 10, the defined parameter comprising at least one of a latency requirement and a jitter requirement specified in a service level agreement for the virtual machine.

14. The computer-readable storage medium of claim 10, comprising a plurality of instructions, that when executed, enable processing circuitry to determine a latency and jitter for each of a plurality of virtual machine monitors and generate a latency and jitter model based, at least in part, on the determined latencies.

15. The computer-readable storage medium of claim 10, comprising a plurality of instructions, that when executed, enable processing circuitry to initiate the virtual machine on one of the plurality of virtual machine monitors based on the latency and jitter model and a service level agreement for the virtual machine.

16. The computer-readable storage medium of claim 10, comprising a plurality of instructions, that when executed, enable processing circuitry to cause each network interface to communicate a packet to each other network interface through the virtual machine monitor to determine an instantaneous latency between the network interfaces.

17. The computer-readable storage medium of claim 10, comprising a plurality of instructions, that when executed, enable processing circuitry to:
cause each network interface to communicate a packet to each other network interface through the virtual machine monitor on a periodic basis;
determine an instantaneous latency after each communication; and
update a latency and jitter model after each period using at least the instantaneous latency.

18. The computer-readable storage medium of claim 10, wherein at least one of the network interfaces comprising a virtual network interface of a virtual machine supported by the virtual machine monitor.

19. A computer-implemented method, comprising:
causing communication of one or more packets from one or more network interfaces to one or more other network interfaces through a virtual machine monitor;
determining latency or jitter for the virtual machine monitor based, at least in part, on each of the one or more packets communicated through the virtual machine monitor; and
performing a corrective action when the latency or the jitter does not meet a defined parameter for a virtual machine on the virtual machine monitor.

20. The computer-implemented method of claim 19, the corrective action comprising one or more of moving the virtual machine on the virtual machine monitor to a different virtual machine monitor, and initiating the virtual machine on a different virtual machine monitor for the corrective action.

21. The computer-implemented method of claim 19, the defined parameter comprising at least one of a latency requirement and a jitter requirement specified in a service level agreement for the virtual machine.

22. The computer-implemented method of claim 19, comprising:
determining a latency and a jitter for each of a plurality of virtual machine monitors; and
generating a latency and jitter model based, at least in part, on the determined latencies and jitter.

23. The computer-implemented method of claim 19, comprising initiating the virtual machine on one of the plurality of virtual machine monitors based on the latency and jitter model and a service level agreement for the virtual machine.

24. The computer-implemented method of claim 19, comprising causing each network interface to communicate a packet to each other network interface through the virtual machine monitor to determine an instantaneous latency between the network interfaces.

25. The computer-implemented method of claim 19, comprising:
causing each network interface to communicate a packet to each other network interface through the virtual machine monitor on a periodic basis;
determining an instantaneous latency after each communication; and
updating a latency and jitter model after each period using at least the instantaneous latency.
